(19) United States
(12) Patent Application Publication
(10) Pub. No.: US 2025/0025835 A1
(43) Pub. Date: Jan. 23, 2025

(54) Membrane Distiller and Membrane Distillation Assembly Comprising Such Membrane Distiller

(71) Applicant: NSS Water Enhancement Technology AB, Bengtsfors (SE)

(72) Inventor: Björn Holmström, Karlstad (SE)

(21) Appl. No.: 18/712,933

(22) PCT Filed: Nov. 21, 2022
(86) PCT No.: PCT/EP2022/082550

§ 371 Date: May 23, 2024

(30) Foreign Application Priority Data
Nov. 24, 2021 (SE) 2151428-6

(51) Int. Cl. B01D 61/36; B01D 69/02; B01D 69/12; B01D 71/26; B01D 71/34; B01D 71/36

(52) U.S. Cl. CPC B01D 61/366; B01D 61/364; B01D 69/02; B01D 69/1213; B01D 71/262; B01D 71/34; B01D 71/36; B01D 2313/22; B01D 2325/02834; B01D 2325/04

(57) ABSTRACT

A membrane distillation assembly for providing purified water, and to a membrane distiller including an evaporation chamber, a condensation chamber, and a membrane separating the evaporation chamber and the condensation chamber from each other. The membrane has a pore size equal to or less than 1000 nanometres. The membrane distiller wherein the membrane is a multi-layer polymer membrane including a nonwoven first layer having a pore size equal to or less than 1000 nanometres and a spunbonded second layer that is laminated to the first layer. The second layer is facing the condensation chamber.

### CROSS-REFERENCE TO RELATED APPLICATIONS

This application is the United States national phase of International Patent Application No. PCT/EP2022/082550 filed Nov. 21, 2022, and claims priority to Swedish Patent Application No. 2151428-6 filed Nov. 24, 2021, the disclosures of which are hereby incorporated by reference in their entireties.

### BACKGROUND OF THE INVENTION

### Field of the Invention

The present invention relates in general to a membrane distillation assembly configured for removing particles from water, i.e. producing purified water, to be used in industrial applications, and especially to a membrane distiller configured for producing the purified water. More precisely the present invention relates to a membrane distillation assembly capable of producing nano/ultra-purified water that does not comprise any particles greater than 10 nanometers.

The present invention relates in particular to a membrane distiller comprising an evaporation chamber, a condensation chamber, and a membrane separating the evaporation chamber and the condensation chamber from each other, wherein the membrane has a pore size equal to or less than 1000 nanometres.

The present invention also relates to a membrane distillation assembly comprising:
a membrane distiller that is configured for producing purified water, the membrane distiller having an evaporation chamber and a condensation chamber, wherein the evaporation chamber and the condensation chamber are separated from each other by a membrane, wherein the membrane has a pore size equal to or less than 1000 nanometres,
a reservoir connected to the membrane distiller, the reservoir being configured for intermediate storing of purified water,
a water supply unit connected to the membrane distiller, and
a purified water dispenser tool connected to the reservoir.

Such membrane distillers and membrane distillation assemblies are especially useful in the semiconductor manufacturing industry, wherein the semiconductor wafers are passing several washing steps using purified water.

### Description of Related Art

The present invention is based on the fact that the semiconductors are getting smaller and smaller to meet the requests for faster and less expensive electronics consuming less energy. Thus, the semiconductors/structures on the silicon wafers becomes smaller and the distances between them becomes smaller in order to have the wafers comprising more semiconductors/structures. Thus, the demand for more efficient washing of the wafers from also very small contaminations increase in order to prevent short-circuiting and malfunction of the semiconductors, and thereto the water used has to be ultra-purified water in order to not have the water contaminate the wafers. The washing of wafers consumes large volumes of ultra-purified water in order to obtain the requested washing result, however the production of ultra-purified water is time consuming and energy demanding and the useful life of produced ultra-purified water is short, i.e. less than 30 minutes. Thereto, transportation of purified water in tanks or pipes give rise to contaminations, i.e. based on growth of present contaminations and based on addition of contaminations from the materials of the tank/pipes. Known membrane distillation assemblies does not manage to produce the requested volume of purified water, since known technique is too slow.

Thereto prior solutions have had problems of connecting/welding the membrane to its carrier/frame in order to obtain a sealed relationship between the evaporation chamber and the condensation chamber. Thus, when the membrane during mounting of the membrane distiller is not perfectly connected/welded to the carrier/frame there might be leaks if the membrane is distorted or creased.

Thus, there is a need for an apparatus configured for efficient production of large volumes of ultra-purified water close to the site of utilization, i.e. at the washing station in the clean room, at the time of utilization. In addition to using the purified water as detergent, it may also be used as a solvent in different industrial applications.

### OBJECT OF THE INVENTION

The aim of the present invention is to set aside the drawbacks and shortcomings of the previously known membrane distillers and membrane distillation assemblies and to provide an improved membrane distiller and membrane distillation assembly. A primary object of the present invention is to provide an improved membrane distiller and membrane distillation assembly of the initially defined type that provides the requested volumes of purified water at all times and that can be used in the clean room of a semiconductor/wafer manufacturing plant. It is another object of the present invention to provide a membrane distiller and membrane distillation assembly, wherein the production and the utilization of the purified water can be made concurrently and continuously. It is another object of the present invention to provide a membrane distiller and membrane distillation assembly, wherein the degree of purification of the purified water is increased and thereby the requested volume of purified water decrease. It is another object of the present invention to provide a membrane distiller and membrane distillation assembly, consuming less tap water. It is another object of the present invention to provide a membrane distiller and membrane distillation assembly wherein the membrane is more easily secured in the membrane distiller.

### SUMMARY OF THE INVENTION

According to the invention at least the primary object is attained by means of the initially defined membrane distiller and membrane distillation assembly having the features defined in the independent claims. Preferred embodiments of the present invention are further defined in the dependent claims.

According to the present invention, there is provided a membrane distiller and membrane distillation assembly of the initially defined type, which is characterized in that membrane is a multi-layer polymer membrane comprising a nonwoven first layer having a pore size equal to or less than 1000 nanometres and a spunbonded second layer that is laminated to the first layer, wherein the second layer is facing the condensation chamber.

Thus, the present invention is based on the insight of having a new design/construction of the membrane that improves the ability to increase the production of purified water and secures problem free production of purified water. More precisely, the inventive multilayer membrane entails higher yield without jeopardizing the requested degree of purification at the same time as the spunbonded second layer guarantee that there is always a distance between the first layer of the membrane and surfaces/walls in the condensation chamber. A contact between the filtering layer of the membrane, i.e. the first layer, and the walls of the condensation chamber, following a higher pressure in the evaporation chamber than in the condensation chamber, will have adverse effect on the yield of the production of purified water.

According to various embodiments of the invention, the first layer of the membrane comprises a fluoropolymer, and the second layer of the membrane comprises a thermoplastic polymer. Thereby the first/filtering layer of the membrane is clearly hydrophobic and may be optimized for obtaining the requested degree of purification and the second layer of the membrane is optimized to provide a stable structure preventing contact between the first layer and the walls of the condensation chamber. More precisely, the second layer will not become compressed but will always provide a volume wherein the vapour from the evaporation chamber may condensate.

According to various embodiments of the invention, the membrane distiller comprises a cooling chamber located adjacent the condensation chamber. Thereby appropriate and efficient cooling of the condensation chamber is attained.

According to various embodiments of the invention, the membrane distiller comprises a polymer film separating the cooling chamber and the condensation chamber from each other. Thereto, the thickness of the film is equal to or more than 0.08 millimetre and equal to or less than 0.25 millimetre. Thereby appropriate and efficient cooling of the condensation chamber is attained, at the same time as the film is appropriately connected/welded to its carrier/frame. A thinner film is extremely hard/impossible to connect/weld to a carrier/frame, and a thicker film will provide less efficient cooling.

Further advantages with and features of the invention will be apparent from the other dependent claims as well as from the following detailed description of preferred embodiments.

### BRIEF DESCRIPTION OF THE DRAWINGS

The terms Fig., Figs., Figure, and Figures are used interchangeably in the specification to refer to the corresponding figures in the drawings.

A more complete understanding of the abovementioned and other features and advantages of the present invention will be apparent from the following detailed description of preferred embodiments in conjunction with the appended drawings, wherein:

FIG. 1 is a schematic illustration of the main components of a membrane distillation assembly,

FIG. 2 is a schematic illustration of a reservoir of the membrane distillation assembly according to a first embodiment,

FIG. 3 is a schematic illustration of a reservoir of the membrane distillation assembly according to a second embodiment,

FIG. 4 is a schematic illustration of a water supply unit of the membrane distillation assembly, is a schematic exploded side view of a membrane distiller according to a schematic FIG. 5 embodiment,

FIG. 6 is a schematic illustration of a side view of the membrane distiller according to FIG. 5,

FIG. 7 is a schematic illustration of a side view of an alternative to the membrane distiller according to FIG. 6,

FIG. 8 is a schematic illustration of a side view of another schematic embodiment of the membrane distiller,

FIG. 9 is a schematic illustration of a first endplate of the membrane distiller according to FIG. 8,

FIG. 10 is a schematic illustration of a first gasket of the membrane distiller according to FIG. 8,

FIG. 11 is a schematic illustration of a first polymer frame of the membrane distiller according to FIG. 8,

FIG. 12 is a schematic illustration of a second gasket of the membrane distiller according to FIG. 8,

FIG. 13 is a schematic illustration of a second polymer frame of the membrane distiller according to FIG. 8,

FIG. 14 is a schematic illustration of a third gasket of the membrane distiller according to FIG. 8, and

FIG. 15 is a schematic illustration of a second endplate of the membrane distiller according to FIG. 8.

### DESCRIPTION OF THE INVENTION

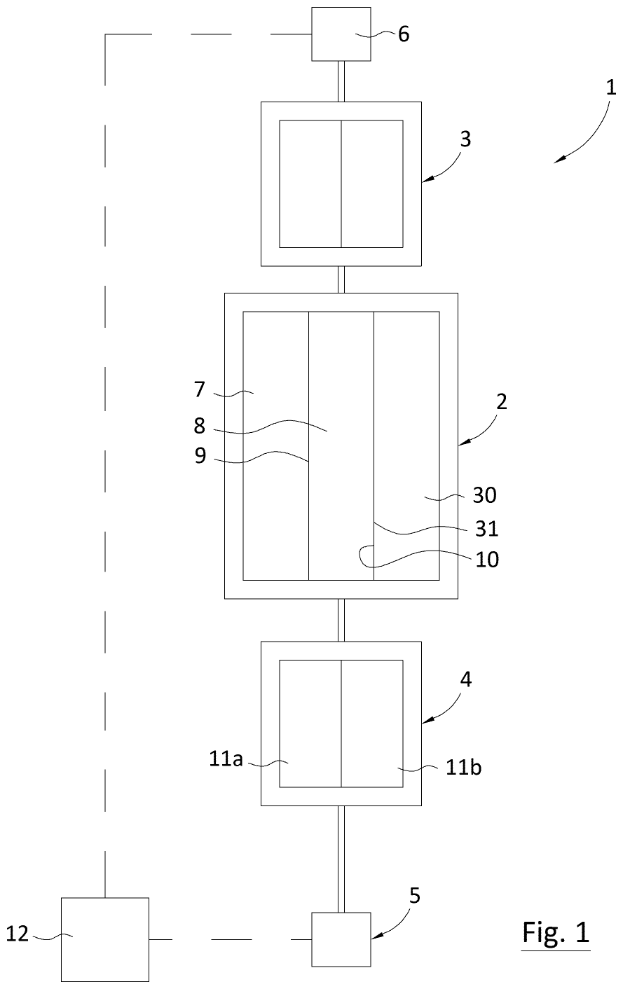

Reference is initially made to FIG. 1 disclosing a schematic illustration of the main components of a membrane distillation assembly, generally designated 1.

The membrane distillation assembly 1 comprise a membrane distiller 2 that is configured for producing purified water, i.e. ultra-clean water, a water supply unit 3 connected to the membrane distiller 2 and configured to supply the water to be treated to the membrane distiller 2, a reservoir 4 connected to the membrane distiller 2 and configured to receive the purified water from the membrane distiller 2, and a purified water dispenser tool 5 connected to the reservoir 4. The reservoir 4 is configured for intermediate/temporary storing the purified water.

The water supply unit 3 is connected to a water source 6, for instance the water mains, i.e. tap water. The purified water dispenser tool 5 may be a manually operated nozzle/handle or an automatically controlled nozzle.

The membrane distiller 2 comprises a sealed evaporation chamber 7 and a sealed condensation chamber 8, wherein the evaporation chamber 7 and the condensation chamber 8 are separated from each other by a membrane 9. The condensation chamber 8 is also known as gas chamber. According to various embodiments the membrane distiller 2 comprises multiple sets of evaporation chambers 7 and condensation chambers 8, wherein such sets are arranged in parallel to each other. Preferably each evaporation chamber 7 is associated with two condensation chambers 8, wherein the condensation chambers 8 are arranged opposite each other, one on each side of the evaporation chamber 7. The membrane 9 has a pore size equal to or less than 1000 nanometres, preferably equal to or less than 750 nanometres, most preferably equal to or less than 500 nanometres. The membrane 9 has a pore size equal to or greater than 100 nanometres. A smaller pore size provides in general a cleaner water but at the same time the production of purified water becomes slower. The pores must be small enough to prevent liquid penetration.

The water supply unit 3 supply water to the condensation chamber 7, i.e. the evaporation chamber 7 is filled with warm water, e.g. equal to or more than 80 degrees Celsius and equal to or less than 90 degrees Celsius. The water as such cannot penetrate the membrane 9 but vapour at the interface between the water and the membrane 9 will penetrate through the membrane 9 into the condensation chamber 8, and leaving contaminations in the evaporation chamber 7. The temperature in the condensation chamber 8 is lower than temperature in the evaporation chamber 7, i.e. the evaporation chamber 8 is cooled, and the vapour will accumulate/condense into droplets in the condensation chamber 8. The condensation chamber 8 comprises a cold surface 10 against which a more efficient condensation of the vapour takes place. The droplets will accumulate and finally flow to the bottom of the condensation chamber 8, and therefrom the purified water will exit the membrane distiller 2 and enter the reservoir 4. The pressure difference between the evaporation chamber 7 and the condensation chamber 8 is equal to or less than 0.5 bar, i.e. the water must not be forced/pressed through the membrane 9.

The membrane 9 shall be manufactured from a thermally and chemically stable material, and preferably a hydrophobic material, such as polytetrafluoroethylene [PTFE], polypropylene [PP], polyvinylidene fluoride [PVDF], etc.

The reservoir 4 comprises at least one tank 11a for intermediate/temporary storing of purified water. However, hereinbelow the reservoir 4 comprises at least two tanks 11a, 11b, but the invention is not limited to a reservoir 4 having two tanks 11a, 11b. The tanks 11a, 11b are connected in parallel with each other between the membrane distiller 2 and the purified water dispenser tool 5. During operation of the membrane distillation assembly 1, the first tank 11a is filled with purified water from the membrane distiller 2 and the second tank 11b supply purified water to the dispenser tool 5, and vice versa. Thus, the reservoir manages to supply ultra-purified water just-in-time at the site of utilization, i.e. the said at least two tanks are filled alternately and supplies ultra-purified water to the dispenser tool alternately. Thereby the production and the utilization of purified water may take place concurrently and continuously.

It shall be pointed out that the first tank 11a does not need to be completely filled up before the purified water from the first tank 11a is utilized, and vice versa. Preferably the first tank 11a is filled to a degree/extent that equals the demand for purified water at the dispenser tool 5 during the time it takes to fill up the second tank 11b, etc.

The purified water that has been used, e.g. during washing of wafers, may be collected in a trough/drain 12 and then recirculated back to the water source 6. The trough/drain 12 may comprise appropriate filters to prevent the contaminants/substances added to the water during the washing step to reach the water source 6. The membrane distillation assembly 1 may also comprise a prefilter located between the water source 6 and the water supply unit 3.

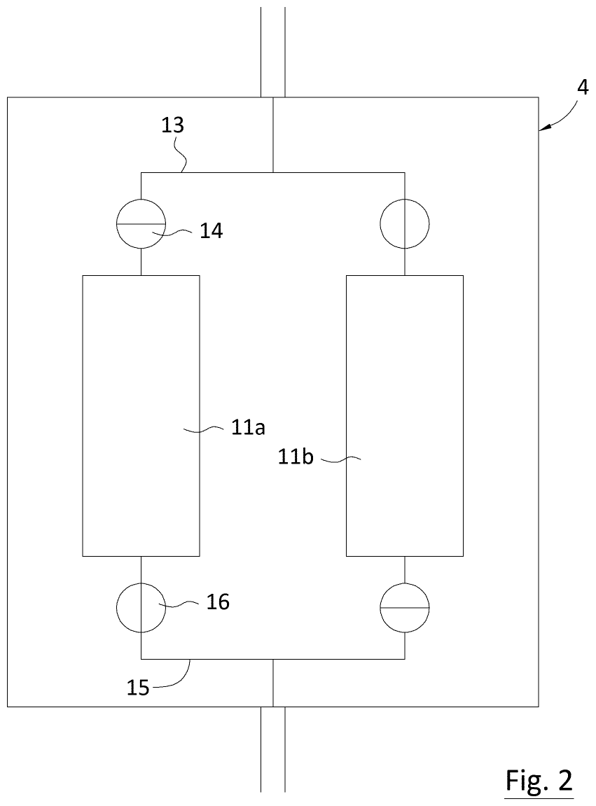

Reference is now made to FIG. 2, disclosing a schematic illustration of the reservoir 4 of the membrane distillation assembly 1 according to a first schematic embodiment.

According to various embodiments, each tank 11a, 11b comprises an intermediate conduit 13 connected to the membrane distiller 2 and having a controllable intermediate valve 14, and an outlet conduit 15 connected to the purified water dispenser tool 5 and having a controllable outlet valve 16. Thereby, the separate tanks of the reservoir 4 may be individually filled and emptied. The tanks 11a, 11b are oriented such that the purified water will automatically flow towards the outlet conduit 15 that is connected to the tank at the lowest point of the tank.

In the event the purified water in the first tank 11a is not completely utilized in time, i.e. before the useful life of the purified water in the first tank 11a has ended and/or when the second tank 11b is full, the remaining content of the first tank 11a is discharged/wasted before the purified water of the second tank 11b is utilized. Said discharge/waste may be a manual operation directing the dispenser tool 5 directly into the through/drain 12. The same applies to a reservoir 4 having only one tank 11a. Thereby any old/unsuitable water of a separate tank may be discharged or recirculated without affecting the supply of purified water to the dispenser tool.

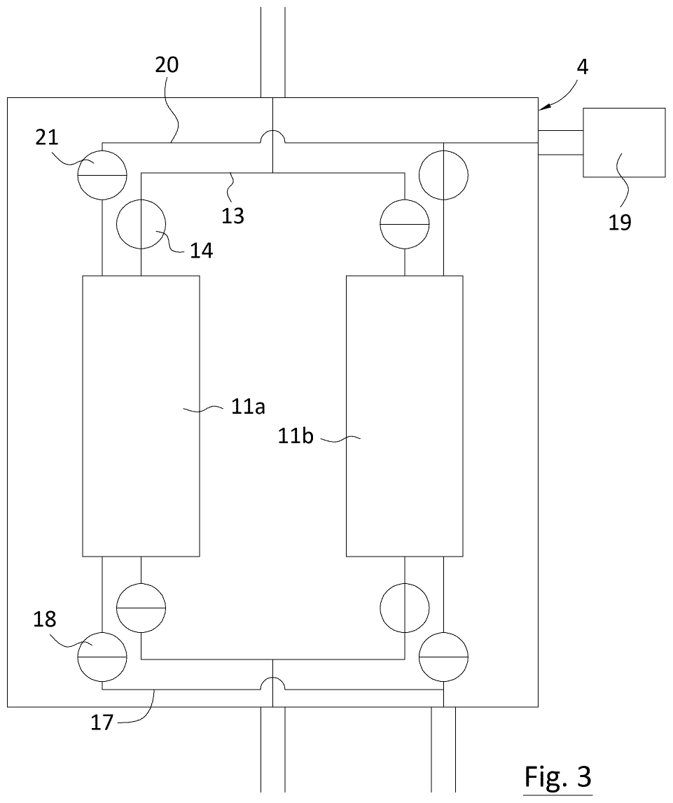

Reference is now also made to FIG. 3, disclosing a schematic illustration of the reservoir 4 of the membrane distillation assembly 1 according to a second schematic embodiment.

According to various embodiments, each tank 11a, 11b comprises a discharge/waste conduit 17 having a controllable discharge valve 18, wherein the discharge conduit 17 bypasses the dispenser tool 5. Using such a solution, the discharge/waste of the surplus content of one tank 11a, 11b may be performed automatically and/or at the same time as the purified water of the other tank 11a, 11b is utilized at the dispenser tool 5. The discharge conduit 17 is preferably connected to the water source 6, directly or indirectly via the through/drain 12. The same applies to a reservoir 4 having only one tank 11a.

When the tank 11a, 11b is emptied, it is important that no residues remain in the tank, since such residues may contaminate the next batch of purified water. According to various embodiments, the membrane distillation assembly 1 comprises a gas source 19, preferably nitrogen or the like gas. Each tank 11a, 11b comprises a gas supply conduit 20 that is connected to the gas source 19 and having a controllable gas valve 21. The pressurized gas from the gas source 19 is utilized to empty the tanks 11a, 11b, via the outlet valve 16 and/or the discharge valve 18. The gas supply conduit 20 is preferably connected to the tank 11a, 11b adjacent the intermediate conduit 13 or via the intermediate conduit 13 downstream the intermediate valve 14.

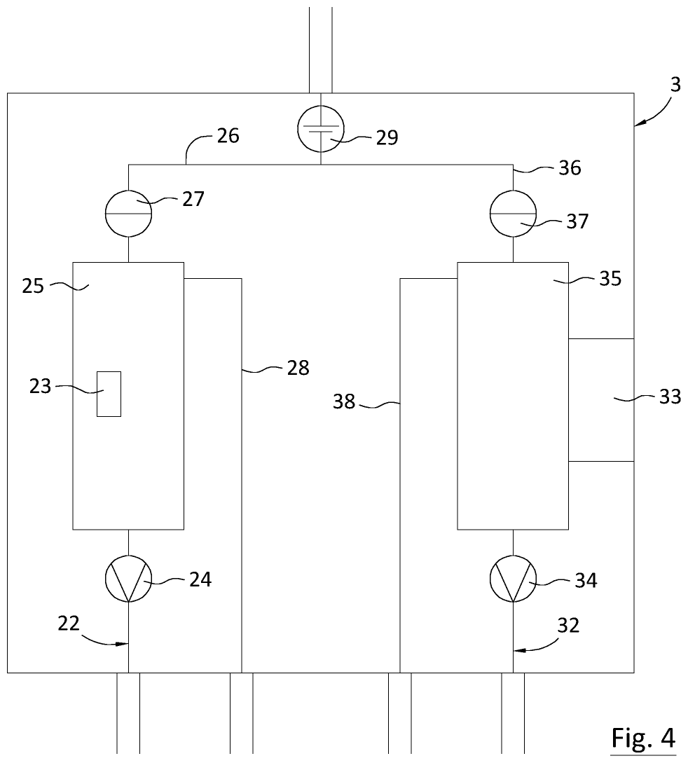

Reference is now also made to FIG. 4, disclosing a schematic illustration of the water supply unit 3 of the membrane distillation assembly 1.

According to various embodiments, the the water supply unit 3 comprises a primary water supply conduit, generally designated 22, connected to the evaporation chamber 7 of the membrane distiller 2, wherein the primary water supply conduit 22 comprises a heater 23. Thus, the water supplied to the evaporation chamber 7 is preheated to the appropriate/correct temperature already when reaching the evaporation chamber.

The primary water supply conduit 22 comprises a water regulator 24 configured for controlling the flow and pressure of the water supplied to the evaporation chamber 7 via the primary water supply conduit 22. The water regulator 24 is preferably constituted by a pump that has to be automatically primed in order to prevent too high pressure in the evaporation chamber 7.

According to various embodiments the water supply unit 3 comprises a buffer tank 25 connected to the primary water supply conduit 22. Preferably the buffer tank 25 is associated with the heater 23, but they may also be located in series with each other. Thereto, a feed water conduit 26 is connected to the buffer tank 25 or to the water regulator 24, and is configured to be connected to the water source 6, wherein the feed water conduit 26 comprises a controllable charging valve 27, in order to charge the buffer tank 25 or to prime the water regulator 24. According to various embodiments, the water supply unit 3 comprises a primary water return conduit 28 extending from the evaporation chamber 7 to the buffer tank 25, wherein the water not purified in the membrane distiller 2, i.e. not passing the membrane 9, is returned/recycled which is beneficial since it already has an elevated temperature. The buffer tank 25 preferably comprises a level sensor, in order to control the charging valve 27. The primary water supply conduit 22 preferably comprises an air vent.

The water supply unit 3 comprises a pressure regulator valve 29 in order not to obtain a too high pressure at the upstream side of the water regulator 24. The pressure regulator valve 29 may be located between the water source 6 and the water supply unit 3.

The flow generated by the water regulator 24 is in the range 1-5 litres/minute, and the production of purified water reaching the reservoir 4 is in the range 1-4 litres/minute.

According to various embodiments, the membrane distiller 2 comprises a sealed cooling chamber 30 located adjacent the condensation chamber 8. Thus, the cooling chamber 30 is configured to provide the cold surface 10. Preferably the membrane distiller 2 comprises a film/partition/foil 31 separating the cooling chamber 30 and the condensation chamber 8 from each other, i.e. the cold surface 10 is part of the film/partition 31. The cooling chamber 30 comprises a liquid/water or gas. The cold surface 10 may alternatively be part of a cooling block/device.

According to various embodiments the thickness of the film 31 is equal to or more than 0.08 millimetre and equal to or less than 0.25 millimetre, preferably equal to or more than 0.1 millimetre and equal to or less than 0.2 millimetre. Thereby, the film 31 is able to withstand deformation and is easy to install, and still have a low insulation effect. The cold surface 10 shall be as smooth as possible, in order to facilitate the purified water to flow downwards. Preferably the film 31 is hydrophobic, in order to facilitate the purified water to flow downwards. The film 31 is preferably a hydrophobic material and preferably comprises a fluoropolymer, such as polyvinylidene fluoride [PVDF].

According to various embodiments, the the water supply unit 3 comprises a secondary water supply conduit, generally designated 32, connected to the cooling chamber 30 of the membrane distiller 2, wherein the secondary water supply conduit 32 comprises a cooler 33. Thus, the water in the cooling chamber 30 has an appropriate temperature to efficiently condensate the vapour in the condensation chamber 8 to purified water.

The secondary water supply conduit 32 comprises a water regulator 34 configured for controlling the flow and pressure of the water supplied to the cooling chamber 30 via the secondary water supply conduit 32. The water regulator 34 is preferably constituted by a pump that has to be automatically primed in order to prevent too high pressure in the cooling chamber 30.

According to various embodiments the water supply unit 3 comprises a buffer tank 35 connected to the secondary water supply conduit 32. Preferably the buffer tank 35 is associated with the cooler 33, but they may also be located in series with each other. Thereto, a feed water conduit 36 is connected to the buffer tank 35 or to the water regulator 34, and is configured to be connected to the water source 6, wherein the feed water conduit 36 comprises a controllable charging valve 37, in order to charge the buffer tank 35 or to provide water to the water regulator 34. According to various embodiments, the water supply unit 3 comprises a secondary water return conduit 38 extending from the cooling chamber 30 to the buffer tank 35, wherein the cooling water is returned/recycled which is beneficial since it will decrease the water usage.

The buffer tank 35 preferably comprises a level sensor, in order to control the charging valve 37. The secondary water supply conduit 32 preferably comprises an air vent.

The cooler 33 is preferably a thermoelectric heat pump, such as a Peltiere device, that transfer heat from one side of the device to the other side using electric energy. The heat is transferred from the liquid/water in the secondary water supply conduit 32, preferably the buffer tank 35, to the surrounding air. According to alternative embodiments, such a thermoelectric heat pump is directly associated with the cooling chamber 30.

At least the reservoir 4 and conduits extending from the condensation chamber 8 to the dispenser tool 5 are preferably treated to have hydrophobic surfaces facing the purified water in order facilitate the flow of purified water.

Reference is now made to FIGS. 5-7, disclosing schematic illustrations of a schematic membrane distillers 2. The membrane distiller 2 comprises a stack of different members/elements in order to provide the evaporation chamber 7, the condensation chamber 8, and the cooling chamber 30. However, a membrane distiller 2 stack may preferably comprise a multiple of such combinations arranged in parallel with each other. Preferably, the top and bottom of the stack comprises a cooling chamber 30 in order to minimize the heat emanation to the surrounding environment/clean room.

The membrane distiller 2 stack according to the disclosed schematic embodiment comprises a first endplate 39 preferably made of metal, an elastic first gasket 40, the membrane 9, a rigid first polymer frame 41, an elastic second gasket 42, a rigid second polymer frame 43, the film 31, an elastic third gasket 44, and a second endplate 45 preferably made of metal.

According to the disclosed embodiments, the first endplate 39 delimits the evaporation chamber 7, and the second endplate 45 delimits the cooling chamber 30, i.e. the endplates delimits the outer/adjacent chambers.

According to the invention, the membrane 9 is a multi-layer polymer membrane comprising a nonwoven first layer 46 having a pore size equal to or less than 1000 nanometres and a spunbonded second layer 47 that is laminated to the first layer 46, wherein the second layer 47 is facing the condensation chamber 8. Thereby the first layer 46 is facing the evaporation chamber 7. According to various embodiments, the thickness of the membrane 9 is equal to or more than 0.1 millimetres and equal to or less than 0.4 millimetres, preferably equal to or more than 0.2 millimetres and equal to or less than 0.3 millimetres. Thus, the first layer 46 of the membrane 9 is the actual filtering layer. The first layer 46 of the membrane 9 preferably comprises a fluoropolymer, such as polytetrafluoroethylene [PTFE] or polyvinylidene fluoride [PVDF], and the second layer 47 of the membrane 9 preferably comprises a thermoplastic polymer, such as polypropylene [PP]. The first layer 46 and the second layer 47 are individually produced before laminated to each other, in order to minimize intrusion of the second layer 47 into the first layer 46 and thereby minimize blockage of the pores of the first layer 46.

The rigid polymer frames/carriers 41, 43 preferably comprises a rigid fluoropolymer such as polyvinylidene fluoride [PVDF], and the elastic gaskets 40, 42, 44 preferably comprises an elastic fluoropolymer such as polytetrafluoroethylene [PTFE]. The rigid polymer frames 41, 43 will remain their initial thickness in response to the membrane distiller 2 is mounted/compressed. The elastic gaskets 40, 42, 44 will obtain a smaller thickness than their initial thickness in response to the membrane distiller 2 is mounted/compressed. The elastic gaskets are preferably compressed equal to or more than 25% of the initial/unloaded thickness, and equal to or less than 40% of the initial/unloaded thickness. Too little compression might result in leaks and too much compression will result in a compact gasket that loses its sealing/elastic properties and might result in leaks. When the membrane distiller 2 stack is mounted/compressed the first endplate 39 and the second endplate 45 are clamped to each other at the same time as distance elements having appropriate length are provided between the endplates in order to prevent over-clamping. Thus, the appropriate length of the distance elements is equal to the sum of the final/compressed thickness of the gaskets and the thickness of the polymer frames.

The first polymer frame 41 has a first surface 48, a second surface 49 and a central aperture 50 extending between the first surface 48 and the second surface 49, and at least a portion of the condensation chamber 8 is constituted by the central aperture 50. The membrane 9 is connected/welded to the first surface 48 of the first polymer frame 41 covering the central aperture 50 and the second layer 47 of the membrane 9 is facing the first surface 48 of the first polymer frame 41. The membrane 9 may be connected to the first polymer frame 41 in other suitable ways such as by means of glue, but welding (ultrasound welding) is preferred. The second layer 47 of the membrane 9 facilitates the connection between the membrane 9 and the first polymer frame 41. Thereby, the first/filtering layer 46 of the membrane 9 does not need to be optimized to be connected/welded to the first polymer frame 41, instead the second layer 47 of the membrane 9 is optimized for being connected/welded to the first polymer frame 41 and the first layer 46 of the membrane 9 is optimized for filtering.

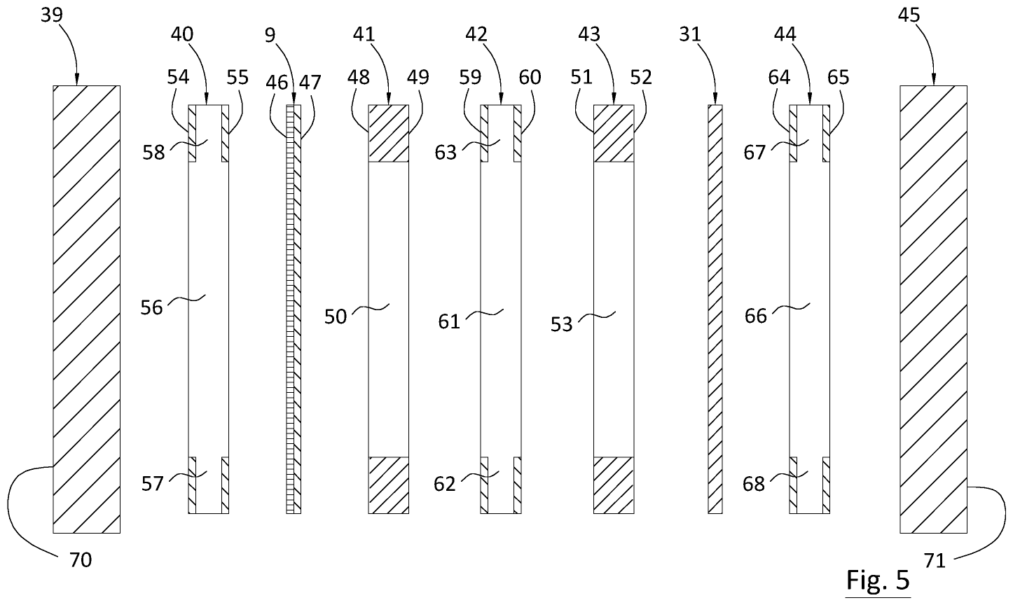

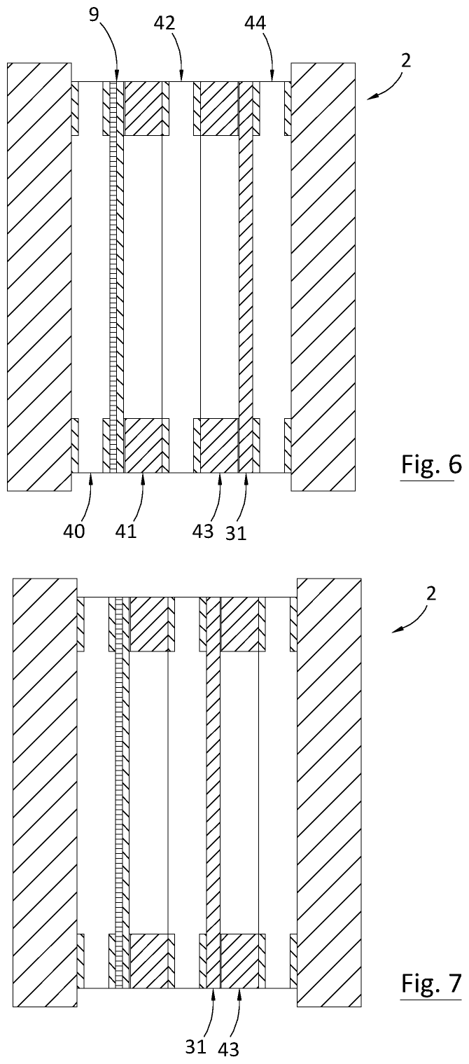

The second polymer frame 43 has a first surface 51, a second surface 52 and a central aperture 53 extending between the first surface 51 and the second surface 52. The film 31 is connected/welded either to the first surface 51 of the second polymer frame 43 covering the central aperture 53 or to the second surface 52 of the second polymer frame 43 covering the central aperture 53. The film 31 may be connected to the second polymer frame 43 in other suitable ways such as by means of glue, but welding (ultrasound welding) is preferred. When the film 31 is connected to the second surface 52 of the second polymer frame 43 (see FIG. 6), the central aperture 53 constitutes at least a portion of the condensation chamber 8. When the film 31 is connected to the first surface 51 of the second polymer frame 43 (see FIG. 7), the central aperture 53 constitutes at least a portion of the cooling chamber 30.

The elastic first gasket 40 has a first surface 54, a second surface 55 and a central aperture 56 extending between the first surface 54 and the second surface 55, at least a portion of the evaporation chamber 7 being constituted by the central aperture 56. An inlet 57 that is part of the primary water supply conduit 22 extends to the central aperture 56 at the lower part of the first gasket 40, and an outlet 58 that is part of the primary water return conduit 28 extends from the central aperture 56 at the upper part of the first gasket 40.

The elastic second gasket 42 has a first surface 59, a second surface 60 and a central aperture 61 extending between the first surface 59 and the second surface 60, at least a portion of the condensation chamber 8 being constituted by the central aperture 61. An outlet 62 that is part of the intermediate conduit 13 extends from the central aperture 61 at the lower part of the second gasket 42. The second gasket 42 may also comprise a vent 63 in order to prevent pressure build up in the condensation chamber 8.

The elastic third gasket 44 has a first surface 64, a second surface 65, and a central aperture 66 extending between the first surface 64 and the second surface 65, at least a portion of the cooling chamber 30 being constituted by the central aperture 66. An inlet 67 that is part of the secondary water supply conduit 32 primary water supply conduit 22 extends to the central aperture 66 at the upper part of the third gasket 44, and an outlet 68 that is part of the secondary water return conduit 38 extends from the central aperture 66 at the lower part of the third gasket 44.

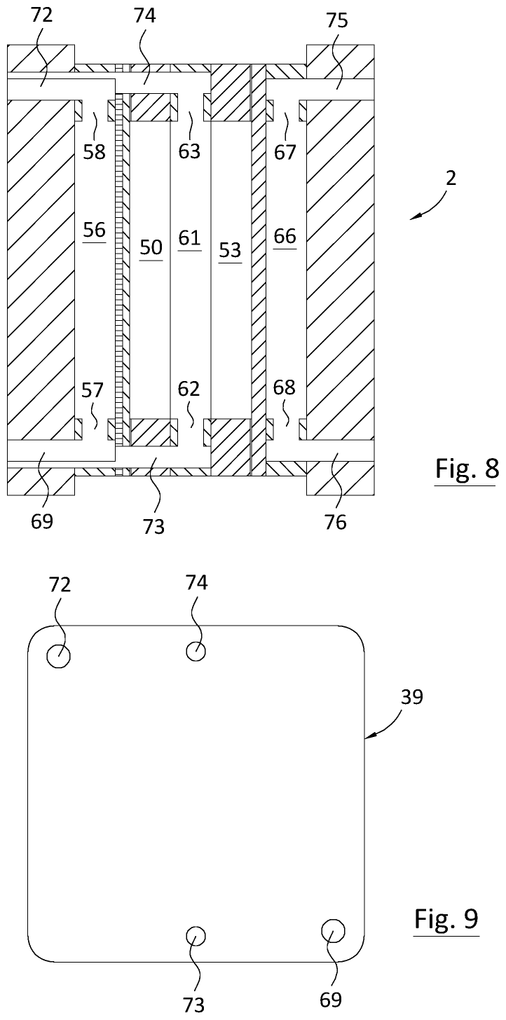

Reference is now also made to FIGS. 8-15, disclosing another schematic illustration of a schematic membrane distiller 2. Only additions/differences to the schematic embodiments of FIGS. 5-7 will be described.

According to various embodiments, the membrane distiller 2 comprises a primary water supply manifold 69 that extends between the first surface 54 and the second surface 55 of the first gasket 40 at the lower part of the first gasket 40, wherein the inlet 57 extends from the primary water supply manifold 69 to the central aperture 56 of the first gasket 40. The primary water supply manifold 69 is part of the primary water supply conduit 22, and extends from the first gasket 40 to outside of the membrane distiller 2, e.g. to the outer surface 70 of the first endplate 39 through any intermediate element. The primary water supply manifold 69 may extend through the entire membrane distiller 2, i.e. from the outer surface 70 of the first endplate 39 to the outer surface 71 of the second endplate 45. All evaporation chambers 7 are preferably connected to the primary water supply manifold 69.

According to various embodiments, the membrane distiller 2 comprises a primary water return manifold 72 that extends between the first surface 54 and the second surface 55 of the first gasket 40 at the upper part of the first gasket 40, wherein the outlet 58 extends from the central aperture 56 of the first gasket 40 to the primary water return manifold 72. The primary water return manifold 72 is part of the primary water return conduit 28, and extends from the first gasket 40 to outside of the membrane distiller 2, e.g. to the outer surface 70 of the first endplate 39 through any intermediate element. The primary water return manifold 72 may extend through the entire membrane distiller 2, i.e. from the outer surface 70 of the first endplate 39 to the outer surface 71 of the second endplate 45. All evaporation chambers 7 are preferably connected to the primary water return manifold 72.

According to various embodiments, the membrane distiller 2 comprises a purified water manifold 73 that extends between the first surface 59 and the second surface 60 of the second gasket 42 at the lower part of the second gasket 42, wherein the outlet 62 extends from the central aperture 61 of the second gasket 42 to the purified water manifold 73. The purified water manifold 73 is part of the intermediate conduit 13, and extends from the second gasket 42 to outside of the membrane distiller 2, e.g. to the outer surface 70 of the first endplate 39 through any intermediate element. The purified water manifold 73 may extend through the entire membrane distiller 2, i.e. from the outer surface 70 of the first endplate 39 to the outer surface 71 of the second endplate 45. All condensation chambers 8 are preferably connected to the purified water manifold 73. The purified water manifold 73 is preferably coated/lined with a hydrophobic material that preferably comprises a fluoropolymer, such as polyvinylidene fluoride [PVDF], in order to secure that the purified water leaves the membrane distiller 2. A coating/lining extending along the purified water manifold 73 entails that the purified water does not risk getting stuck at the interfaces between the different frames and gaskets. The coating/lining must not block the outlets 62 extending from the condensation chambers 8 to the purified water manifold 73.

According to various embodiments, the membrane distiller 2 comprises a vent manifold 74 that extends between the first surface 59 and the second surface 60 of the second gasket 42 at the upper part of the second gasket 42, wherein the vent 63 extends from the central aperture 61 of the second gasket 42 to the vent manifold 74. The vent manifold 74 extends from the second gasket 42 to outside of the membrane distiller 2, e.g. to the outer surface 70 of the first endplate 39 through any intermediate element. The vent manifold 74 may extend through the entire membrane distiller 2, i.e. from the outer surface 70 of the first endplate 39 to the outer surface 71 of the second endplate 45. All condensation chambers 8 are preferably connected to the vent manifold 74.

According to various embodiments, the membrane distiller 2 comprises a secondary water supply manifold 75 that extends between the first surface 64 and the second surface 65 of the third gasket 44 at the upper part of the third gasket 44, wherein the inlet 67 extends from the central aperture 66 of the third gasket 44 to the secondary water supply manifold 75. The secondary water supply manifold 75 is part of the secondary water supply conduit 32, and extends from the third gasket 44 to outside of the membrane distiller 2, e.g. to the outer surface 71 of the second endplate 45 through any intermediate element. The secondary water supply manifold 75 may extend through the entire membrane distiller 2, i.e. from the outer surface 70 of the first endplate 39 to the outer surface 71 of the second endplate 45. All cooling chambers 30 are preferably connected to the secondary water supply manifold 75.

According to various embodiments, the membrane distiller 2 comprises a secondary water return manifold 76 that extends between the first surface 64 and the second surface 65 of the third gasket 44 at the lower part of the third gasket 44, wherein the outlet 68 extends from the central aperture 66 of the third gasket 44 to the secondary water return manifold 76. The secondary water return manifold 76 is part of the secondary water return conduit 38, and extends from the third gasket 44 to outside of the membrane distiller 2, e.g. to the outer surface 71 of the second endplate 45 through any intermediate element. The secondary water return manifold 76 may extend through the entire membrane distiller 2, i.e. from the outer surface 70 of the first endplate 39 to the outer surface 71 of the second endplate 45. All cooling chambers 30 are preferably connected to the secondary water return manifold 76.

FIGS. 9-15 disclose the different elements of the membrane distiller 2 according to FIG. 8, wherein the elements are view upon from the first surface 70 of the first endplate 39.

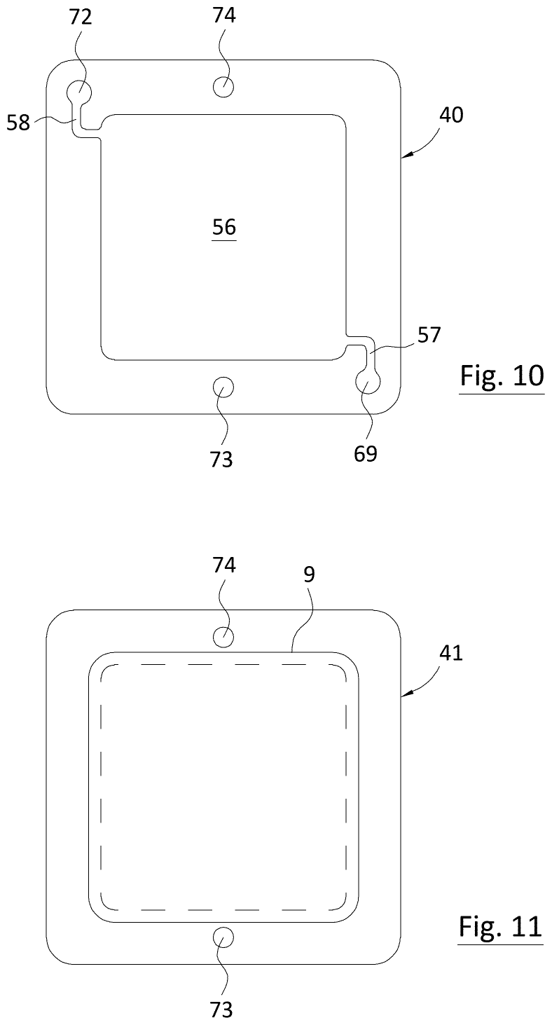

FIG. 10 disclose the first gasket 40, wherein the mouth of the inlet 57 at the central aperture 56 is located at one of the lower corners and wherein the mouth of the outlet 58 at the central aperture 56 is located at the diametrically opposed upper corner, in order to obtain optimal distribution of water/heat in the entire evaporation chamber 7. The cross sectional area of the inlet 57 is preferably less than the cross sectional area of the primary water supply manifold 69, preferably less than 50%. The inlet 57 preferably comprises a bend between the primary water supply manifold 69 and the central aperture 56. The cross sectional area of the outlet 58 is preferably less than the cross sectional area of the primary water return manifold 72, preferably less than 50%. The outlet 57 preferably comprises a bend between the primary water return manifold 72 and the central aperture 56.

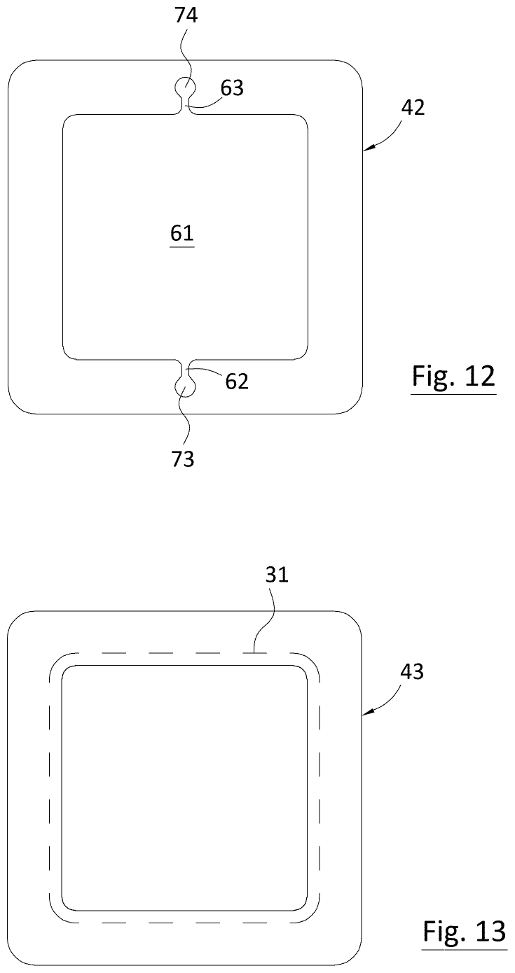

FIG. 12 disclose the second gasket 42, wherein the mouth of the outlet 62 at the central aperture 61 is located at the middle of the bottom and wherein the mouth of the vent 63 at the central aperture 61 is located at the middle of the top, in order to obtain optimal discharge of purified water from the condensation chamber 8.

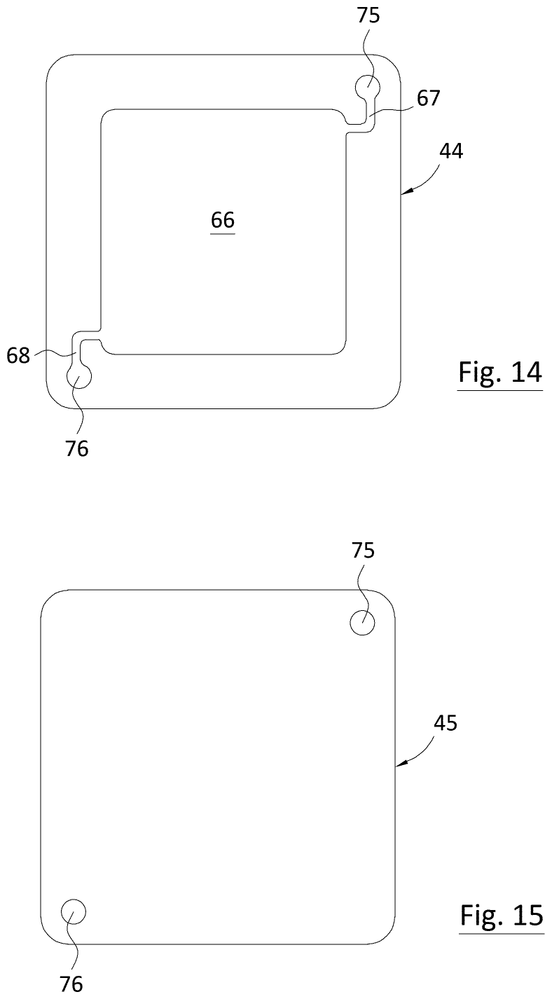

FIG. 14 disclose the third gasket 44, wherein the mouth of the inlet 67 at the central aperture 66 is located at one of the upper corners and wherein the mouth of the outlet 68 at the central aperture 66 is located at the diametrically opposed lower corner, in order to obtain optimal distribution of water/cold in the entire cooling chamber 30. The cross sectional area of the inlet 67 is preferably less than the cross sectional area of the secondary water supply manifold 75, preferably less than 50%. The inlet 67 preferably comprises a bend between the secondary water supply manifold 75 and the central aperture 66. The cross sectional area of the outlet 68 is preferably less than the cross sectional area of the secondary water return manifold 76, preferably less than 50%. The outlet 67 preferably comprises a bend between the secondary water return manifold 76 and the central aperture 66.

The primary water supply manifold 69 and the secondary water return manifold 76 are preferably located at one lower corner each of the membrane distiller 2, and the primary water return manifold 72 and the secondary water supply manifold 75 are preferably located at one upper corner each of the membrane distiller 2.

### Feasible Modifications of the Invention

The invention is not limited to only the abovementioned and embodiments shown in the drawings, which only have an illustrating and exemplifying purpose. This patent application is intended to cover all modifications and variants of the preferred embodiments described herein, and the present invention is consequently defined by the wording of the enclosed claims and the equipment can thus be modified in all conceivable ways within the framework of the enclosed claims.

It should also be pointed out that all information about/concerning terms such as above, below, upper, lower, etc. shall be interpreted/read with the equipment oriented in accordance with the figures, with the drawings oriented in such a way that the reference numbers can be read in a correct manner. Consequently, such terms only indicate relative relationships in the shown embodiments, which relationships can be changed if the equipment according to the invention is provided with another construction/design.

It shall also be pointed out that even thus it is not explicitly stated that features from a specific embodiment may be combined with features from another embodiment, the combination shall be considered obvious, if the combination is possible.

1-10. (canceled)

11. A membrane distiller for producing purified water, the membrane distiller comprising:
an evaporation chamber,
a condensation chamber, and
a membrane separating the evaporation chamber and the condensation chamber from each other, wherein the membrane has a pore size equal to or less than 1000 nanometres,
wherein the membrane is a multi-layer polymer membrane comprising a nonwoven first layer having a pore size equal to or less than 1000 nanometres and a spunbonded second layer that is laminated to the first layer, wherein the second layer is facing the condensation chamber,
wherein the membrane distiller comprises a cooling chamber located adjacent the condensation chamber, wherein a polymer film separates the cooling chamber and the condensation chamber from each other, the thickness of the polymer film being equal to or more than 0.08 millimetre and equal to or less than 0.25 millimetre.

12. The membrane distiller according to claim 11, wherein the thickness of the membrane is equal to or more than 0.1 millimetres and equal to or less than 0.4 millimetres, preferably equal to or more than 0.2 millimetres and equal to or less than 0.3 millimetres.

13. The membrane distiller according to claim 11, wherein the pore size of the first layer of the membrane is equal to or less than 750 nanometres, preferably equal to or less than 500 nanometres.

14. The membrane distiller according to claim 11, wherein the first layer of the membrane comprises a fluoropolymer, such as polytetrafluoroethylene [PTFE] or polyvinylidene fluoride [PVDF].

15. The membrane distiller according to claim 11, wherein the second layer of the membrane comprises a thermoplastic polymer, such as polypropylene [PP].

16. The membrane distiller according to claim 11, wherein the thickness of the film is equal to or more than 0.1 millimetre and equal to or less than 0.2 millimetre.

17. The membrane distiller according to claim 11, wherein the polymer film comprises a fluoropolymer, such as polyvinylidene fluoride [PVDF].

18. A membrane distillation assembly for providing purified water, the membrane distillation assembly comprising,
a membrane distiller that is configured for producing purified water, the membrane distiller having an evaporation chamber and a condensation chamber, wherein the evaporation chamber and the condensation chamber are separated from each other by a membrane, wherein the membrane has a pore size equal to or less than 1000 nanometres,
a reservoir connected to the membrane distiller, the reservoir being configured for intermediate storing of purified water,
a water supply unit connected to the membrane distiller, and
a purified water dispenser tool connected to the reservoir,
wherein the membrane is a multi-layer polymer membrane comprising a nonwoven first layer having a pore size equal to or less than 1000 nanometres and a spunbonded second layer that is laminated to the first layer, wherein the second layer is facing the condensation chamber, and in that the membrane distiller comprises a cooling chamber located adjacent the condensation chamber, wherein a polymer film separates the cooling chamber and the condensation chamber from each other, the thickness of the polymer film being equal to or more than 0.08 millimetre and equal to or less than 0.25 millimetre.
